(19) United States
(12) Patent Application Publication
(10) Pub. No.: US 2026/0014891 A1
(43) Pub. Date: Jan. 15, 2026

(54) SYSTEMS AND METHODS FOR FACILITATING VEHICLE CHARGING

(71) Applicant: Ford Global Technologies, LLC, Dearborn, MI (US)

(72) Inventors: Kai Wu, Pittsburgh, PA (US); Dominique Meroux, Ann Arbor, MI (US); Xiaowu Zhang, Novi, MI (US); Najibesadat Sadatijafarkalaei, McKinney, TX (US); Chen Zhang, South Lyon, MI (US)

(73) Assignee: Ford Global Technologies, LLC, Dearborn, MI (US)

(21) Appl. No.: 18/769,992

(22) Filed: Jul. 11, 2024

(51) Int. Cl. B60L 53/64; B60L 53/62; B60L 53/66

(52) U.S. Cl. CPC B60L 53/64; B60L 53/62; B60L 53/66

(57) ABSTRACT

A vehicle charging optimization system including a transceiver and a processor is disclosed. The transceiver may be configured to receive a trigger signal from a user device associated with a user. The processor may be configured to render a communication interface on the user device responsive to obtaining the trigger signal from the user device, and obtain a user preference for charging a vehicle associated with the user via the communication interface responsive to rendering the communication interface. The processor may further determine a charger type preference of the user based on the user preference. The processor may perform a first predefined action when the charger type preference is of a first type, and a second predefined action when the charger type preference is of a second type.

### FIELD

The present disclosure relates to systems and methods for facilitating electric vehicle (EV) charging via public and private chargers.

### BACKGROUND

Electric Vehicles (EVs) require regular charging at EV charging stations to ensure optimal vehicle operation. As the EV adoption increases, the number of EVs has increased considerably, resulting in a surge of demand for charging solutions/stations. While the number of charging stations is steadily increasing, the rate of growth of charging stations has not matched the EV charging infrastructure needs. Consequently, many users are known to face inconvenience in identifying available charging stations.

Furthermore, many-a-times, even if users are able to identify available charging stations, the reliability of infrastructure/components in existing charging stations still causes inconvenience to the users. For example, there are known instances of users facing inconvenience at the charging stations when one or more chargers are faulty.

Thus, a system and method is required that facilitates a user to conveniently and efficiently charge an EV.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a view of a vehicle Human-Machine Interface (HMI) displaying information associated with available private chargers in a geographical area in accordance with the present disclosure.

FIG. 3 depicts an example graph of energy pricing at different times of a day in accordance with the present disclosure.

FIG. 4 depicts an example view of a vehicle tire being located over a charging cord in accordance with the present disclosure.

FIG. 5 depicts a flow diagram of an example vehicle charging optimization method in accordance with the present disclosure.

### DETAILED DESCRIPTION

### Overview

The present disclosure describes a vehicle charging optimization system (“system”) that may facilitate a user to conveniently identify an available public or private charger according to user's requirements and charge a user's vehicle (which may be an Electric Vehicle (EV)). The user may transmit a request to the system to identify available chargers via a user device or a vehicle Human-Machine Interface (HMI), when the user desires to charge the vehicle. The request may include an indication of whether the user requires a public charger or a private charger. Responsive to receiving the user's request, the system may perform different predefined actions to facilitate the user to conveniently identify an available charger and charge the vehicle, based on whether the user requires a public or a private charger.

When the user requires a private charger, the user may additionally provide information associated with a required charger availability time duration, a required private charger geolocation, a charging type, an estimated arrival State of Charge (SoC) level associated with a vehicle battery, a target SoC level, and/or the like. The information associated with the charging type may include user's preference for bi-directional charging or charging only, and/or user's preference for multi-retrieval capability from the private charger at which the vehicle may get charged. Responsive to receiving the information described above, the system may correlate the information with pre-stored private charger information (that may be stored in a system memory) to identify one or more optimal private chargers for the user/vehicle. The system may further transmit the information associated with the identified optimal private chargers to the user device and/or the HMI, so that the user may select a private charger according to user's preference and get the vehicle charged. In some aspects, the information associated with the identified optimal private chargers may include a charging price, charging CO2 or renewables share, a charger distance from the required private charger geolocation, the charging type, a charging cord length associated with each private charger of the identified optimal private chargers, and/or the like. The system may also facilitate the user's reservation of a private charger for the required charger availability time duration, after the user has selected the private charger to use based on the information transmitted by the system.

In further aspects, when the vehicle may be plugged-in to the private charger, the system may execute smart vehicle charging and discharging operation, such that the vehicle charges when the energy price is low and the vehicle discharges when the energy price is high. The system also ensures that the vehicle is charged to the target SoC level desired by the user at the end of the required charger availability time duration.

When the user requires a public charger, the system may identify one or more available public chargers based on the preferred public charger geolocation provided by the user and public charger information (that may be stored in a system memory and/or obtained from the public chargers in real-time). Responsive to identifying the available public chargers, the system may output a list of available public chargers (ranked by distance from the preferred public charger geolocation) on the user device and/or the HMI, so that the user may select an optimal public charger to charge the vehicle.

The system may additionally enable a plurality of users connected with the system via respective user devices to communicate with each other via the system (e.g., via a message board or a communication interface provided by the system) and share messages/notifications associated with available chargers. The system may also determine availability and/or error status associated with user's preferred chargers, and notify the user regularly about the status, so that the user may conveniently plan the vehicle charging.

The present disclosure discloses a vehicle charging optimization system that assists a user in conveniently identifying available chargers for vehicle charging. The system enables private charger owners to monetize idle charging slots by offering them to long-distance EV drivers. The system further provides a communication interface (e.g., a customer-to-customer communication framework) using which the efficiency of public charging may be considerably enhanced. The system further provides personalized charging recommendations and real-time availability information to the users, which fosters charger sharing and schedule coordination. The system further notifies the users about unavailable chargers or potential incompatibilities due to software issues, thereby aiding in effective planning and locating of alternative charging options for the vehicles.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

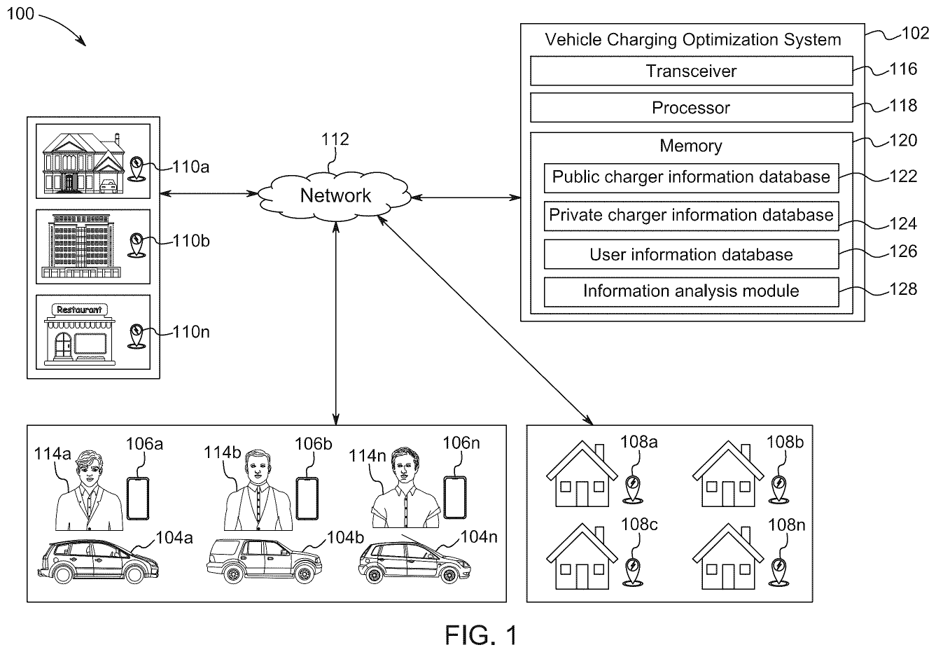

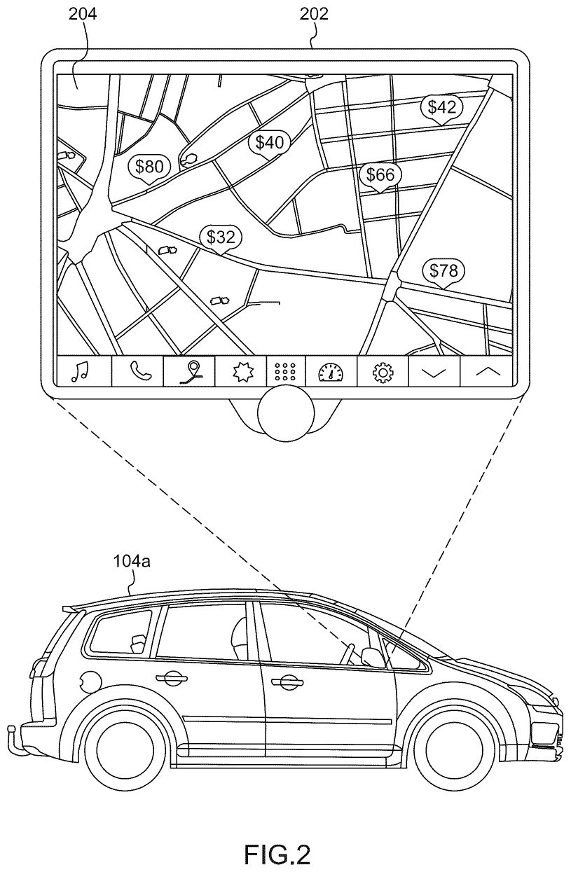

FIG. 1 depicts an environment 100 in which techniques and structures for providing the systems and methods disclosed herein may be implemented. While describing FIG. 1, references will be made to FIGS. 2, 3 and 4.

The environment 100 may include a vehicle charging optimization system 102 (or system 102) that may be communicatively coupled with a plurality of vehicles 104a, 104b, 104n (collectively referred to as vehicles 104), a plurality of user devices 106a, 106b, 106n (collectively referred to as user devices 106), a plurality of private chargers 108a, 108b, 108c, 108n (collectively referred to as private chargers 108), a plurality of public chargers 110a, 110b, 110n (collectively referred to as public chargers 110), one or more servers (not shown), and/or the like, via one or more networks 112. The system 102 may be hosted on a server or a distributed computing system, and may be a combination of hardware, software and/or firmware.

The plurality of vehicles 104a, 104b, 104n and the plurality of user devices 106a, 106b, 106n may be associated with a plurality of users 114a, 114b, 114n, respectively. Each vehicle 104 may take the form of any passenger or commercial vehicle such as a car, a work vehicle, a crossover vehicle, a truck, a van, a minivan, a taxi, a bus, etc. Each vehicle 104 may be a manually driven vehicle or may be configured to operate in a partially/fully autonomous mode. In an exemplary aspect, each vehicle 104 may be an Electric Vehicle (EV) or a hybrid vehicle. Further, one or more vehicles (e.g., the vehicle 104a) may be a bi-directional EV. A bi-directional EV, as described herein the present disclosure, may mean a vehicle that may be configured to obtain electric energy from a charging station/charger during vehicle charging operation and also transfer energy from a vehicle energy storage (e.g., a vehicle battery, not shown) back to the charging station or to the grid/another vehicle/equipment during vehicle discharging operation. Stated another way, electric energy flows from the grid to the vehicle 104a via the charging station during the vehicle charging operation, and electric energy flows from the vehicle 104a (specifically from the vehicle's battery) to the grid or another vehicle/equipment during the vehicle discharging operation.

In some aspects (as shown in FIG. 1), each user device 106 may be, for example, a mobile phone, a laptop, a computer, a smartwatch, or any other device with communication capacities. In other aspects, the user device 106 may also be a vehicle Human-Machine Interface (HMI). The illustration of the user device 106 as a mobile phone in FIG. 1 should not be construed as limiting.

Each private and public charger 108, 110 may be configured to enable the vehicles 104 to charge. Stated another way, the vehicle 104 may obtain energy or get charged at the private and public chargers 108, 110. Each private charger 108 may be installed or located at private properties or homes of charger owners. The private chargers 108 may not be available publicly and at all the times to charge the vehicles 104, and may only be made available for vehicle charging when the respective charger owners offer one or more vehicles 104 to charge by using the private chargers 108. Stated another way, one or more vehicles 104 may charge at the private chargers 108 only when the respective charger owners make the private chargers 108 available for charging.

Each public charger 110 may be installed at public properties such as malls, public parking areas/lots, office buildings, housing apartment complex, restaurants, etc. The public chargers 110 may be available publicly, and the vehicles 104 may get charged at the public chargers 110 at any time, based on the availability of respective public chargers 110. In an exemplary aspect, the vehicles 104 may get charged at the public chargers 110 on a first come, first serve basis.

The network 112, as described herein, illustrates an example communication infrastructure in which the connected devices discussed in various embodiments of this disclosure may communicate. The network 112 may be and/or include the Internet, a private network, public network or other configuration that operates using any one or more known communication protocols such as transmission control protocol/Internet protocol (TCP/IP), Bluetooth® Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 102 may be configured to facilitate one or more users (e.g., the user 114a) to identify an optimal public or private charger to charge the vehicle 104a as per the user's preferences, travel plan, and/or vehicle's charging requirements. The system 102 may include a plurality of components/units including, but not limited to, a transceiver 116, a processor 118, and a memory 120, which may be communicatively coupled with each other. The transceiver 116 may be configured to receive/transmit (via the network 112) signals/information/data from/to the vehicles 104, the user devices 106, the private chargers 108 (or computing systems associated with the private chargers 108), the public chargers 110 (or computing systems associated with the public chargers 110), the servers, and/or the like.

For example, the transceiver 116 may be configured to receive the information associated with the private chargers 108 from respective private chargers 108 (or computing systems associated with the private chargers 108) and/or user devices associated with the charger owners. In an exemplary aspect, the information associated with the private chargers 108 include, but is not limited to, an availability time duration of each private charger 108, a geolocation of each private charger 108, the information associated with a charging type of each private charger 108, a price for parking and charging the vehicle 104 at each private charger 108 (and/or service price charged by the respective charger owner to allow vehicle charging at each private charger 108), charger hardware information, and/or the like. The availability time duration of each private charger 108 may indicate a time duration for which the respective charger owner may “offer” the private charger 108 to be used by other vehicles (i.e., vehicles not owned by the charger owner), e.g., the vehicles 104. As an example, the availability time duration of the private charger 108a may indicate that the owner of the private charger 108a has offered the vehicles 104 to charge by using the private charger 108a between Monday, 8 AM till Wednesday, 8 PM (as the charger owner may be going out of town). In some aspects, the availability time duration of each private charger 108 may also indicate the owner's confirmation/consent to park the vehicle 104 at the charger owner's property in proximity to the private charger 108. Stated another way, in the present disclosure, when the charger owner offers the private charger 108 for charging by the vehicle 104, the charger owner also offers the space/area in proximity to the private charger 108 for parking the vehicle 104.

The charging type of each private charger 108 may indicate whether the private charger 108 supports bi-directional vehicle charging (i.e., whether energy can flow both ways, i.e., from and into the private charger 108), or the private charger 108 may only be used for vehicle charging and cannot receive energy back from the vehicle 104. The charging type of each private charger 108 may also indicate whether the charger owner allows multi-retrieval from the private charger 108 or would prefer the vehicle 104 to stay connected for a longer time duration.

In some aspects, the price for parking and charging the vehicle 104 at each private charger 108 may be provided by the respective charger owner to the transceiver 116 via the owner's user device, computing system associated with the private charger 108 or directly via the private charger 108. In an exemplary aspect, the price for parking and charging the vehicle 104 may also include service fees (if any) that may be charged by the charger owner.

The charger hardware information may include the information associated with whether the private charger 108 supports fast charging, a charging cord length associated with the private charger 108, and/or the like.

In a similar manner, the transceiver 116 may be configured to receive the information associated with the public chargers 110 from respective public chargers 110 (or computing systems associated with the public chargers 110), user devices associated with a plurality of users who may be using the public chargers 110 or may have used the public chargers 110 in the past, the servers, and/or the like. In an exemplary aspect, the information associated with the public chargers 110 include, but is not limited to, an availability status (specifically, a real-time availability status), user reviews, a geolocation, a real-time energy price, a real-time grid demand, a real-time marginal emissions rate from added grid demand or prevented grid demand, or a lower or zero marginal emissions rate associated with an on-site private energy storage and renewable power generation setup, an operational status associated with each public charger 110, and/or the like.

As another example, the transceiver 116 may be configured to receive requests from the users 114 to identify available public or private chargers via the user devices 106 and/or the vehicles 104 (e.g., via respective vehicle HMIs), user preferences for charging respective vehicles 104, user reviews associated with specific public or private chargers (e.g., the chargers that may have been used by the users 114), messages, signals, notifications, and/or the like.

The processor 118 may be in communication with one or more memory devices in communication with the respective computing systems (e.g., the memory 120 and/or one or more external databases not shown in FIG. 1). The processor 118 may utilize the memory 120 to store programs in code and/or to store data for performing aspects in accordance with the disclosure. The memory 120 may be a non-transitory computer-readable storage medium or memory storing a program code that enables the processor 118 to perform operations in accordance with the present disclosure. The memory 120 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 120 may include a plurality of databases and modules including, but not limited to, a public charger information database 122, a private charger information database 124, a user information database 126, the information analysis module 128, and/or the like. The public charger information database 122 may be configured to store the information associated with the public chargers 110, and the private charger information database 124 may be configured to store the information associated with the private chargers 108 described above. The user information database 126 may be configured to store requests, user preferences, user reviews, messages, signals, notifications, and/or the like, obtained from the users 114 via the user devices 106 and/or the vehicles 104. The information analysis module 128 may be stored in the form of computer-executable instructions (e.g., in the form of generative artificial intelligence (AI) algorithm), and the processor 118 may be configured and/or programmed to execute the stored computer-executable instructions for performing functions/operations in accordance with the present disclosure. For example, the processor 118 may execute the computer-executable instructions stored in the information analysis module 128 to analyze the information associated with the public chargers 110 (e.g., a plurality of user reviews associated with the public chargers 110, the information associated with their availability and/or operational status, etc.), and identify optimal public charger(s) for a user based on user's requirements/preferences, as described later in the description below.

In operation, when a user (e.g., the user 114a) desires to identify a charger to charge the vehicle 104a, the user 114a may transmit a trigger signal or a request to identify available chargers to the transceiver 116 via the user device 106a and/or an HMI (shown as HMI 202 in FIG. 2) associated with the vehicle 104a. The transceiver 116 may receive the trigger signal from the user device 106a and/or the HMI 202, and may transmit the trigger signal to the processor 118.

The processor 118 may obtain the trigger signal, and may cause the user device 106a and/or the HMI 202 to render a communication interface associated with the system 102 on the user device 106a and/or the HMI 202, responsive to obtaining the trigger signal. The communication interface may be, for example, a message board, a user interface of an application (“app”) associated with the system 102, and/or the like. Responsive to rendering the communication interface, the processor 118 may output a notification on the communication interface, requesting the user 114a to provide a user preference for charging the vehicle 104a. The user 114a may view/hear the notification, and may then input the user preference on the communication interface.

Responsive to the user 114a inputting the user preference, the processor 118 may obtain the user preference via the communication interface (and the user preference may also be stored in the user information database 126). In some aspects, the user preference may include or be associated with a charger type preference of the user 114a for the vehicle 104a charging. In an exemplary aspect, the charger type preference may be of a first type when the user 114a desires to use a private charger to charge the vehicle 104a, and may be of a second type when the user 114a desires to use a public charger to charge the vehicle 104a. Stated another way, the charger type preference may be of the first type when the user preference provided by the user 114a includes a request to identify private chargers to charge the vehicle 104a, and may be of the second type when the user preference provided by the user 114a includes a request to identify public chargers to charge the vehicle 104a.

Responsive to obtaining the user preference via the communication interface, the processor 118 may analyze the user preference, and determine the charger type preference of the user 114a for the vehicle 104a charging based on the analysis. The processor 118 may then perform a first predefined action when the charger type preference is of the first type, and a second predefined action when the charger type preference is of the second type. Stated another way, the processor 118 may perform the first predefined action when the user 114a desires to charge the vehicle 104a via a private charger, and perform the second predefined action when the user 114a desires to charge the vehicle 104a via a public charger. Examples of the first and second predefined actions are described below. The examples described below should not be construed as limiting, and the processor 118 may perform one or more additional or alternative actions based on the charger type preference of the user 114a.

In an exemplary aspect, responsive to determining that the user preference includes a request to identify private chargers or to perform the first predefined action, the processor 118 may transmit a first information request to the user device 106a and/or the HMI 202, via the transceiver 116 and the network 112. The first information request may be associated with a request to seek one or more preferred vehicle charging parameters associated with the vehicle 104a from the user 114a. In an exemplary aspect, the preferred vehicle charging parameters may include, a required charger availability time duration, a required private charger geolocation, a charging type, a charger capacity (e.g., maximum charging speed; for AC charging, this may be 3.2 kW or 19 kW), an estimated arrival State of Charge (SoC) level associated with a vehicle battery, a target SoC level, and/or the like. The charging type may be, for example, a preference of the user 114a for bi-directional charging or charging only, a preference for multi-retrieval capability from the private charger at which the vehicle 104a may get plugged/charged, and/or the like.

The user 114a may view/hear the first information request on the user device 106a and/or the HMI 202, and may input the preferred vehicle charging parameters on the user device 106a and/or the HMI 202. As an example, if the user 114a is planning to visit a new city for three days and desires a private charger to park and charge the vehicle 104a, the user 114a may input a vehicle arrival time as 8 AM on Monday and a vehicle departure time as 4 PM on Wednesday (as the required charger availability time duration), geolocation of an area where the user 114a desires to visit as the required private charger geolocation, “smart bi-directional charging” as the charging type (and information indicating that the user 114a may not require multi-retrieval capability from the private charger), the estimated arrival SOC level of 25% and the target SoC level at departure of 90%. By inputting smart bi-directional charging as the charging type, the user 114a may indicate to the system 102 that the user 114a desires to obtain charge/energy from the private charger (e.g., during the vehicle's charging operation) and also transfer energy back to the private charger/grid via the vehicle's battery (e.g., during the vehicle's discharging operation). The estimated arrival SOC level of 25% may indicate to the system 102 that the user 114a expects the vehicle 104a to have 25% SoC level when the vehicle 104a reaches the area geolocation provided by the user 114a (e.g., at 8 AM on Monday), and desires to have 90% SoC level when the vehicle 104a departs from the area geolocation (e.g., at 4 PM on Wednesday).

When the user 114a inputs the preferred vehicle charging parameters as described above, the processor 118 may obtain the preferred vehicle charging parameters from the user device 106a and/or the HMI 202 (e.g., via the transceiver 116 and the network 112). Responsive to obtaining the preferred vehicle charging parameters, the processor 118 may fetch the information associated with the private chargers 108 from the private charger information database 124, and may correlate the preferred vehicle charging parameters with the fetched information. The processor 118 may further identify one or more optimal private chargers (from the private chargers 108) for the user 114a/vehicle 104a based on the correlation. For example, based on the correlation, the processor 118 may identify those private chargers that may be located at or in proximity to the geolocation provided by the user 114a, may be available for the required charger availability time duration and may have bi-directional charging capability.

Responsive to identifying the optimal private chargers for the user 114a/vehicle 104a, the processor 118 may transmit the information associated with the identified optimal private chargers to the user device 106a and/or the HMI 202, which may display the information as shown in FIG. 2. In an exemplary aspect, the information associated with the identified optimal private chargers may include a charging price (which may be a combination of vehicle parking and charging price, and service fees charged by the charger owner), charging CO2 or renewables share, a charger distance from the required private charger geolocation or the geolocation provided by the user 114a as part of the preferred vehicle charging parameters, the charging type, a charging cord length associated with each private charger of the identified optimal private chargers, and/or the like. In the exemplary aspect depicted in FIG. 2, the information associated with the identified optimal private chargers is shown on a digital map 204 rendered on the HMI 202. In some aspects, the map 204 may include location icons or markers associated with the identified optimal private chargers, and pricing details (and other details described above) associated with each identified optimal private charger.

The user 114a may view/hear and analyze the information associated with the identified optimal private chargers, and may then select a private charger (e.g., the private charger 108a) from the identified optimal private chargers at which the user 114a may desire to park and charge the vehicle 104a based on the analysis. For example, the user 114a may select a private charger that may have the lowest associated charging price, or a private charger that may be closest to the geolocation input by the user 114a as part of the preferred vehicle charging parameters, and/or the like.

Responsive to the user 114a selecting the private charger 108a, the processor 118 may obtain the selection of the private charger 108a from the user device 106a and/or the HMI 202, and then reserve the private charger 108a for the user 114a/vehicle 104a responsive to obtaining the selection. In this case, the processor 118 may transmit a reservation command signal to the computing device associated with the private charger 108a and/or the user device associated with the charger owner to reserve the private charger 108a for the required charger availability time duration for the user 114a/vehicle 104a. The processor 118 may also share a digital key with the user device 106a and/or the vehicle 104a, which may enable the user 114a to conveniently use the private charger 108a when the vehicle 104a reaches the private charger 108a.

In some aspects, when the vehicle 104a reaches the private charger 108a (e.g., at 8 AM on Monday) and the user 114a plugs-in the vehicle 104a to the private charger 108a (e.g., by using the digital key described above), the computing device associated with the private charger 108a and/or the vehicle 104a may transmit a vehicle plug-in signal to the transceiver 116. The processor 118 may obtain the vehicle plug-in signal from the transceiver 116, and may determine that the vehicle 104a has plugged-in to the private charger 108a responsive to obtaining the plug-in signal.

The processor 118 may fetch real-time and historical information associated with energy demand and energy price at different times of the day from the grid, one or more servers, and/or the like, responsive to determining that the vehicle 104a is plugged-in to the private charger 108a. The processor 118 may then execute a smart vehicle charging and discharging operation, such that the vehicle 104a charges at a time duration when the energy price is low and discharges at a time duration when the energy price is high, while at the same time ensuring that at the end of the required charger availability time duration (i.e., at 4 PM on Wednesday), the vehicle 104a should have an SoC level of 90% (as desired by the user 114a).

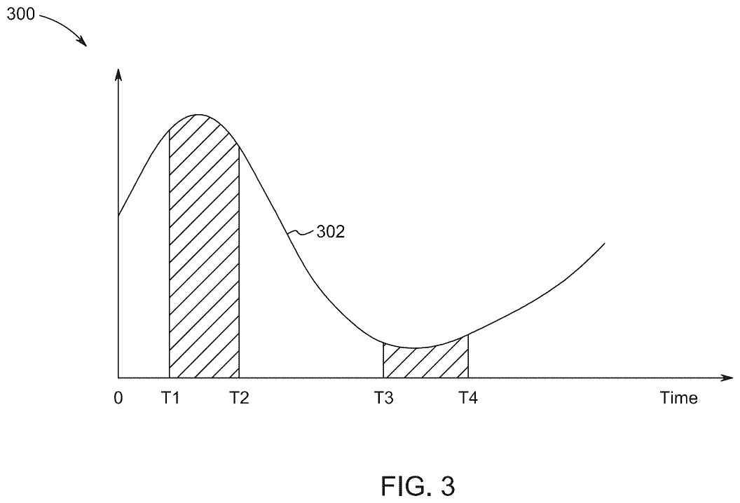

An example graph 300 depicting a curve 302 between utility energy price and time is shown in FIG. 3. The graph's Y-axis depicts utility energy price (e.g., utility energy price per unit energy, kWh), and the graph's X-axis depicts time of a day. As shown in the graph 300, the utility energy price may be highest between times T1 and T2 (which may be peak hours of energy demand, e.g., during day time), and the energy price may be lowest between times T3 and T4 (which may be off-peak hours of energy demand, e.g., during night time). Responsive to executing the smart vehicle charging and discharging operation, the processor 118 may transmit a charging command signal to the vehicle 104a and/or the private charger 108a to activate and continue the vehicle charging operation via the private charger 108a between the times T3 and T4 (i.e., when the utility energy price may be low or less than a first predefined threshold). During this time, the vehicle 104a may obtain energy from the grid via the private charger 108a and get charged.

In a similar manner, the processor 118 may transmit a discharging command to the vehicle 104a and/or the private charger 108a to activate and continue the vehicle discharging operation via the private charger 108a between the times T1 and T2 (i.e., when the utility energy price may be high or greater than a second predefined threshold). During this time, the vehicle 104a may transfer energy from the vehicle battery to the grid via the private charger 108a and get discharged. The processor 118 may follow the process of vehicle charging and discharging, as described above, for the entire duration for which the vehicle 104a may be plugged-in to the private charger 108a. As described above, the processor 118 may activate the vehicle charging and discharging operation such that the vehicle SoC level at the end of the required charger availability time duration (i.e., by 4 PM on Wednesday) is equivalent to the target SoC level desired by the user 114a (i.e., 90%).

In some aspects, the processor 118 may execute the smart vehicle charging and discharging operation to minimize price for the user 114a, which includes both price for charging the vehicle 104a and the price associated with discharging and losses. An example mathematical expression of the price is illustrated below.

$$J = {\sum }_{k = 1}^{Nk} {CP}_{r}^{k} - ( 1 - C ) {DP}_{r}^{k} + γ {E}_{loss}^{k} ,$$

where C=1 when charging and C=0 when discharging; Pr is the charging price at different times (k) of day, and DPr is discharging price at different times (k) of day. Further, Nₖ is the overall amount of minutes the customer/vehicle 104a has been in charging/discharging; “r” is the pricing at different utility territories; and γ is the unit price for energy loss for discharging/charging, which can be tuned while solving the optimization problem

In the mathematical expression illustrated above, “J” is the overall price for vehicle charging and discharging, “Pr” denotes the charging price, which is a function of the total energy drawn from the grid between k−1 and k. It depends on the price at different times of the day multiplied by P_{batt} (the negative battery power). “DPr” represents the discharging price, which is a function of the total energy delivered to the home between k−1 and k. It depends on the price at different times of the day multiplied by P_{batt} (the positive battery power). Further, “E” is the energy loss during vehicle charging and discharging operation. The processor 118 may execute the smart vehicle charging and discharging operation to minimize the overall price “J”. The overall price may be further subject to system dynamics (e.g., vehicle's SoC) and constraints, as illustrated below in example mathematical expressions.

$$SOC ( k + 1 ) = - [ \frac{{V}_{oc} ( k ) - \sqrt{{V}_{oc}^{2} ( k ) - 4 {P}_{batt} ( k ) {R}_{i n t} ( k )}}{2 {R}_{i n t} ( k ) {Q}_{batt}} ] Δ t + SOC ( k )$$

In the mathematical expression illustrated above, V_{oc} is the open circuit voltage of the battery pack, P_{batt} is battery power, Rᵢₙₜ is the battery's total internal resistance, and Q_{batt} is the battery total capacity. The constraints in the smart vehicle charging and discharging operation though is that the battery power should be between maximum and minimum rated battery power, and SOC should be between maximum and minimum rated battery SoC, as illustrated below.

$${P}_{batt m i n} \leq {P}_{batt} ( k ) \leq {P}_{batt m ax}$$

$${SOC}_{m i n} \leq SOC ( k ) \leq {SOC}_{ma x}$$

By executing the smart vehicle charging and discharging operation described above when the vehicle 104a is plugged-in to the private charger 108a for a long time duration, the processor 118 provides greater flexibility in accommodating home energy requirements of the charger owner and maintaining charging speed constraints, thereby ensuring no adverse effects on the vehicle's battery health.

In further aspects, responsive to determining that the user preference includes a request to identify public chargers or to perform the second predefined action, the processor 118 may transmit a second information request to the user device 106a and/or the HMI 202, via the transceiver 116 and the network 112. The second information request may be associated with a request to seek a required public charger geolocation from the user 114a, at which the user 114a desires to charge the vehicle 104a. The user 114a may view/hear the second information request on the user device 106a and/or the HMI 202, and may input the required public charger geolocation on the user device 106a and/or the HMI 202.

When the user 114a inputs the required public charger geolocation, the processor 118 may obtain the required public charger geolocation from the user device 106a and/or the HMI 202 (e.g., via the transceiver 116 and the network 112). Responsive to obtaining the required public charger geolocation, the processor 118 may fetch the information associated with the public chargers 110 from the public charger information database 122 and execute the generative artificial intelligence (AI) algorithm included in the information analysis module 128 to analyze the fetched information. In some aspects, the processor 118 may execute the generative AI algorithm on the information associated with the public chargers 110 to scan and analyze the availability information, the geolocation information, the user reviews, the operational status, etc. associated with each public charger 110.

Responsive to analyzing the information by executing the generative AI algorithm described above, the processor 118 may correlate the required public charger geolocation with the information associated with the public chargers 110 based on the information analysis, to determine one or more optimal public chargers (from the public chargers 110) for the user 114a/vehicle 104a based on the correlation. As an example, the processor 118 may determine those public chargers for the user 114a/vehicle 104a that may be closest to the required public charger geolocation, may have good user reviews, may be available and operational at the time of the system 102 receiving the request to identify public chargers from the user 114a, may have low energy rates, and/or the like.

Responsive to determining the optimal public chargers, the processor 118 may transmit, via the transceiver 116, the information associated with the determined optimal public chargers to the user device 106a and/or the HMI 202. In an exemplary aspect, the information associated with the optimal public chargers may include a geolocation information associated with each optimal public charger, displayed on the user device 106a and/or the HMI 202 as a list of chargers ranked by distance from the required public charger geolocation. The user 114a may view/hear the information associated with the optimal public chargers, and may drive to a public charger (e.g., the public charger 110a) of user's choice based on the information, to charge the vehicle 104a. In this manner, the processor 118 enables the user 114a to conveniently identify an available public charger and charge the vehicle 104a.

The system 102 provides additional features to the user 114a that considerably enhances user's convenience of identifying chargers to charge the vehicle 104a. For example, responsive to determining that the user preference includes the request to identify public chargers or to perform the second predefined action, the processor 118 may additionally output/broadcast an indication of the request to identify public chargers obtained from the user 114a to a plurality of communication interfaces associated with a plurality of user devices (not shown) that may be communicatively coupled with the system 102. The plurality of user devices described above may be part of a community that uses a plurality of private and public chargers, and may assist other users (and each other) in identifying available chargers.

Responsive to receiving the indication/broadcast from the processor 118, one or more users may respond to the broadcast by transmitting a response message back to the processor 118. The response message may provide the information associated with an available public charger. For example, the response message may state, “If you need a charge, I've just freed up a charger a little further down in the garage at Village and Howard”. The processor 118 may obtain such a response message from a user device (e.g., a second user device or the user device 106b), and cause the communication interface associated with the user device 106a and/or the HMI 202 to output the response message. The user 114a may view/hear the response message and may drive the vehicle 104a to the available public charger. In this manner, the processor 118 facilitates community notification/message sharing, using which the users may share useful information associated with available and operational chargers with each other.

The processor 118 may be further configured to determine one or more preferred public chargers regularly used by the user 114a to charge the vehicle 104a, based on the information associated with historical charging data of the vehicle 104a (that may be stored in the memory 120, the vehicle 104a and/or one or more servers communicatively coupled with the system 102). Responsive to determining the preferred public chargers, the processor 118 may determine/obtain a real-time availability or error status information associated with the preferred public chargers based on the information associated with the public chargers 110. The processor 118 may then output the real-time availability or error status information on the communication interface associated with the user device 106a and/or the HMI 202, so that the user 114a may be aware if the preferred charger is not available or may be experiencing any hardware or software issue (e.g., potential incompatibilities due to firmware error associated with an Electric Vehicle Supply Equipment (EVSE) or vehicle software issue) that may cause inconvenience to the user 114a while charging the vehicle 104a. A person ordinarily skilled in the art may appreciate that such automated notifications regarding availability and/or error status of preferred chargers may considerably enhance user's convenience of charging the vehicle 104a.

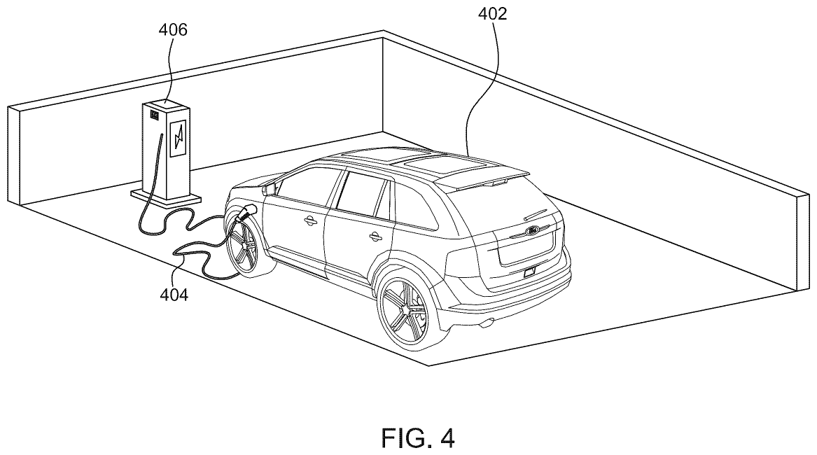

The system 102 may further enable the users to communicate with each other, e.g., if they identify a faulty condition associated with a charger. For example, as shown in FIG. 4, if a vehicle 402 is parked/located on a charging cord 404 associated with a charger 406, one or more users associated with the system 102 may notify the system 102 about the situation shown in FIG. 4 (i.e., the vehicle tire is on the charging cord 404), which may then transmit a notification to the owner of the vehicle 402. As an example, in this case, the processor 118 may output a notification on a user device associated with the vehicle 402 owner indicating that the charging cord 404 may be located under the vehicle 402 tire. Responsive to hearing/viewing the notification, the vehicle 402 owner may move the vehicle 402, thereby preventing any adverse situation associated with the charging cord 404.

The vehicles 104 and the system 102 implement and/or perform operations, as described here in the present disclosure, in accordance with the owner manual and safety guidelines. In addition, any action taken by the users 114 based on the notifications/recommendations provided by the system 102 should comply with all the rules specific to the location and operation of the vehicles 104 (e.g., Federal, state, country, city, etc.). The notifications/recommendations, as provided by the system 102, should be treated as suggestions and only followed according to any rules specific to the location and operation of the vehicles 104.

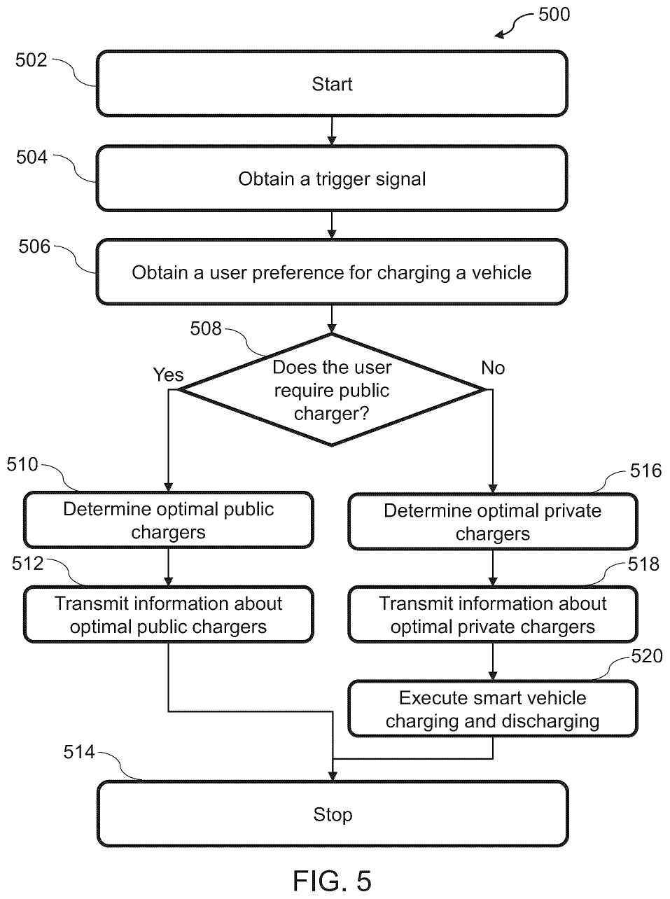

FIG. 5 depicts a flow diagram of an example vehicle charging optimization method 500 in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include obtaining, by the processor 118, the trigger signal or the request to identify available chargers from the user device 106a and/or the HMI 202. At step 506, the method 500 may include obtaining, by the processor 118, the user preference for charging the vehicle 104a from the user 114a, responsive to obtaining the trigger signal. At step 508, the method 500 may include determining, by the processor 118, whether the user 114a requires a public charger or a private charger based on the user preference, as described above.

Responsive to determining that the user 114a requires a public charger, the processor 118 may determine the optimal public chargers for the user 114a/vehicle 104a as described above, at step 510. At step 512, the method 500 may include transmitting, by the processor 118, the information associated with the optimal public chargers to the user device 106a and/or the HMI 202. After the step 512, the method 500 may move to step 514, at which the method 500 may stop.

On the other hand, responsive to determining that the user 114a requires a private charger, the processor 118 may determine the optimal private chargers for the user 114a/vehicle 104a as described above, at step 516. At step 518, the method 500 may include transmitting, by the processor 118, the information associated with the optimal private chargers to the user device 106a and/or the HMI 202. At step 520, the method 500 may include executing, by the processor 118, the smart vehicle charging and discharging operation, as described above. After the step 520, the method 500 may move to the step 514, at which the method 500 may stop

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to receive a trigger signal from a first user device associated with a first user; and
a processor configured to:
render a communication interface on the first user device responsive to obtaining the trigger signal from the first user device;
obtain a first user preference for charging a vehicle associated with the first user via the communication interface, responsive to rendering the communication interface;
determine a charger type preference of the first user based on the first user preference; and
perform a first predefined action when the charger type preference is of a first type, and a second predefined action when the charger type preference is of a second type.

2. The system of claim 1, wherein the trigger signal is associated with a request to identify available chargers for the vehicle.

3. The system of claim 1, wherein the charger type preference is of the first type when the first user preference comprises a request to identify private chargers.

4. The system of claim 3, wherein to perform the first predefined action, the processor is configured to:
transmit a first information request to the first user device responsive to determining that the first user preference comprises the request to identify private chargers;
obtain a preferred vehicle charging parameter from the first user device responsive to transmitting the first information request;
identify one or more optimal private chargers, of a plurality of private chargers, based on the preferred vehicle charging parameter; and
transmit the information associated with the one or more optimal private chargers to the first user device.

5. The system of claim 4, wherein the preferred vehicle charging parameter comprises at least one of a required charger availability time duration, a required private charger geolocation, a charging type, a charger capacity, an estimated arrival State of Charge (SoC) level associated with a vehicle battery, or a target SoC level.

6. The system of claim 5, wherein the charging type comprises at least one of a preference for bi-directional charging or charging only, or a preference for multi-retrieval capability from the one or more optimal private chargers.

7. The system of claim 5, wherein the processor is further configured to:
obtain a selection of a private charger, of the one or more optimal private chargers, from the first user device, responsive to transmitting the information associated with the one or more optimal private chargers; and
reserve the private charger for the first user.

8. The system of claim 7, wherein the processor is further configured to:
determine that the vehicle is plugged-in to the private charger;
activate a vehicle charging via the private charger when a utility energy price is less than a first predefined threshold; and
activate a vehicle discharging via the private charger when the utility energy price is greater than a second predefined threshold,
wherein the processor activates the vehicle charging and vehicle discharging such that a vehicle SoC level at an end of the required charger availability time duration is equivalent to the target SoC level.

9. The system of claim 4 further comprising a memory configured to store the information associated with the plurality of private chargers, wherein the information associated with the plurality of private chargers comprises at least one of an availability time duration of each private charger, a geolocation of each private charger, or the information associated with a charging type of each private charger, and wherein the processor is further configured to:
fetch the information associated with the plurality of private chargers from the memory, responsive to obtaining the preferred vehicle charging parameter;
correlate the preferred vehicle charging parameter with the information associated with the plurality of private chargers; and
identify the one or more optimal private chargers based on the correlation.

10. The system of claim 4, wherein the information associated with the one or more optimal private chargers comprises at least one of a charging price, charging CO2 or renewables share, a charger distance from a required private charger geolocation, a charging type, or a charging cord length associated with each private charger of the one or more optimal private chargers.

11. The system of claim 1, wherein the charger type preference is of the second type when the first user preference comprises a request to identify public chargers.

12. The system of claim 11, wherein to perform the second predefined action, the processor is further configured to:
transmit a second information request to the first user device responsive to determining that the first user preference comprises the request to identify public chargers;
obtain a required public charger geolocation from the first user device responsive to transmitting the second information request;
identify one or more optimal public chargers, of a plurality of public chargers, based on the required public charger geolocation; and
transmit the information associated with the one or more optimal public chargers to the first user device.

13. The system of claim 12 further comprising a memory configured to store the information associated with the plurality of public chargers, wherein the information associated with the plurality of public chargers comprises at least one of an availability status, user reviews, a geolocation, a real-time energy price, a real-time grid demand, a real-time marginal emissions rate from added grid demand or prevented grid demand, or a lower or zero marginal emissions rate associated with an on-site private energy storage and renewable power generation setup, or an operational status associated with each public charger, and wherein the processor is further configured to:
fetch the information associated with the plurality of public chargers from the memory, responsive to obtaining the required public charger geolocation;
correlate the required public charger geolocation with the information associated with the plurality of public chargers; and
identify the one or more optimal public chargers based on the correlation.

14. The system of claim 13, wherein the processor is further configured to:
execute a generative artificial intelligence algorithm to analyze the information associated with the plurality of public chargers; and
correlate the required public charger geolocation with the information associated with the plurality of public chargers based on the analysis.

15. The system of claim 12, wherein the information associated with the one or more optimal public chargers comprises a geolocation information associated with each public charger of the one or more optimal public chargers.

16. The system of claim 11, wherein to perform the second predefined action, the processor is further configured to:
output an indication of the request to identify public chargers from the first user to a plurality of communication interfaces associated with a plurality of user devices;
obtain a response message from a second user device, of the plurality of user devices, associated with a second user, responsive to outputting the indication; and
output the response message on the communication interface associated with the first user device.

17. The system of claim 1, wherein the processor is further configured to:
determine one or more preferred public chargers used by the first user to charge the vehicle based on the information associated with historical charging data of the vehicle;
determine a real-time availability or error status information associated with the one or more preferred public chargers; and
output the real-time availability or error status information on the communication interface associated with the first user device.

18. The system of claim 1, wherein the first user device is a vehicle Human-Machine Interface (HMI).

19. A vehicle charging optimization method comprising:
rendering, by a processor, a communication interface on a user device associated with a user, responsive to obtaining a trigger signal from the user device;
obtaining, by the processor, a user preference for charging a vehicle associated with the user via the communication interface, responsive to rendering the communication interface;
determining, by the processor, a charger type preference of the user based on the user preference; and
performing, by the processor, a first predefined action when the charger type preference is of a first type, and a second predefined action when the charger type preference is of a second type.

20. A non-transitory computer-readable storage medium having instructions stored thereupon which, when executed by a processor, cause the processor to:
render a communication interface on a user device associated with a user, responsive to obtaining a trigger signal from the user device;
obtain a user preference for charging a vehicle associated with the user via the communication interface, responsive to rendering the communication interface;
determine a charger type preference of the user based on the user preference; and
perform a first predefined action when the charger type preference is of a first type, and a second predefined action when the charger type preference is of a second type.
